(19) United States
(12) Patent Application Publication
(10) Pub. No.: US 2004/0246544 A1
(43) Pub. Date: Dec. 9, 2004

(54) Image sensor array with multiple exposure times

(75) Inventors: Paul A. Hosier, Rochester, NY (US); Frederick O. Hayes III, Ontario, NY (US); Scott L. TeWinkle, Ontario, NY (US)

Correspondence Address: PATENT DOCUMENTATION CENTER, XEROX CORPORATION, 100 CLINTON AVE., SOUTH, XEROX SQUARE, 20TH FLOOR, ROCHESTER, NY, 14644, US

(73) Assignee: Xerox Corporation

(21) Appl. No.: 10/455,249

(22) Filed: Jun. 5, 2003

(51) Int. Cl. H04N 1/21; H04N 1/46

(52) U.S. Cl. 358/514; 358/302

(57) ABSTRACT

In a scanner for recording hard-copy images, the image moves relative to a sensor bar including three linear arrays of photosensors. For each small area in the image, the photosensor in one linear array records reflected light with a short exposure time, while each photosensor in the other linear arrays records reflected light with a longer exposure time. The “center of gravity” of the short exposure time is substantially aligned with a combined center of gravity of the two long exposure times.

### INCORPORATION BY REFERENCE

U.S. Pat. Nos. 5,519,514 and 6,115,139, both assigned to the assignee hereof, are incorporated by reference.

### TECHNICAL FIELD

The present disclosure relates to image sensor arrays, as would be found, for instance, in a digital copier or other machine in which an original hard-copy image is recorded as digital data.

### BACKGROUND

Monochrome image sensor arrays typically comprise a linear array of photosensors which raster scan an image bearing document and convert the microscopic image area viewed by each photosensor to image signal charges. Following an integration period, the image signals are amplified and transferred to a common output line or bus through successively actuating multiplexing transistors.

A known basic design of an image sensor array includes three rows of photosensors, each functioning as a linear array. In one variant, each linear array is provided with a translucent primary-color filter, so that the three rows can be used to record primary-color separations of a full-color image. Alternately, multiple rows of photosensors, such as within a single chip, can each be adapted for monochrome recording of an image.

### DESCRIPTION OF THE PRIOR ART

U.S. Pat. No. 5,416,611 describes a raster input scanner in which two rows of photosensors are used to make, in effect, two recordings of an original image. One row of photosensors records the image with a relatively short integration (or exposure) time for each small area of the image; a second row records the same image with a relatively long integration time for each small area of the image. The two recordings can in various ways be combined into a single image data set, resulting in an overall recording of the image over a very wide range of light intensities.

U.S. Pat. No. 5,519,514, incorporated by reference, discloses a raster input scanner using three rows of photosensors. By precise operation of the circuitry associated with each row, the effective exposure or integration time for each row can be finely controlled.

U.S. Pat. No. 6,028,299 discloses a CCD-type image sensor device having two linear arrays, one array having a first sensitivity, the other having a second sensitivity.

U.S. Pat. No. 6,115,139 discloses a readout system for a three-row input scanner, in which, for a small area on the image being recorded, the sensor in the middle row reads out its signal before the sensor either of the other two rows.

### SUMMARY OF THE INVENTION

According to one aspect of the present invention, there is provided a method of operating a photosensitive apparatus, the apparatus having at least a first, second, and third photosensor. A recordable image moves relative to the apparatus along a process direction, thereby exposing each photosensor to a series of small areas in the image. The first photosensor is operated with a first integration time relative to each small area in the image, the second photosensor is operated with a second integration time relative to each small area in the image and the third photosensor is operated with a third integration time relative to each small area in the image. The first integration time and the second integration time are approximately equal, and are longer than the third integration time.

### BRIEF DESCRIPTION OF THE DRAWINGS

FIG. 1 is a simplified elevational view showing essential elements of a raster input scanner, as known in the prior art.

FIG. 2 is a simplified plan view of a sensor bar having a set of photosensors associated therewith, as known in the prior art.

FIG. 3 is a diagram demonstrating the operation of a small number of photosensors in a sensor bar, according to one embodiment.

### DETAILED DESCRIPTION

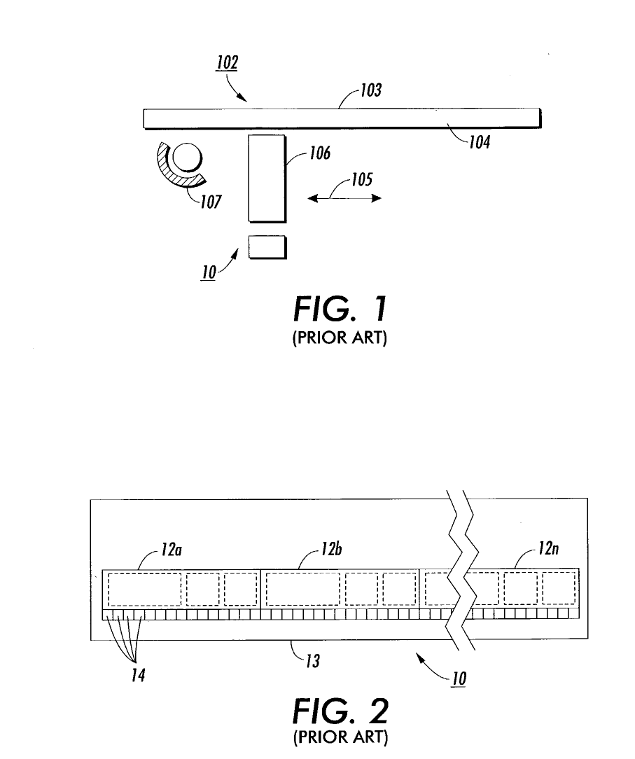

Referring to FIG. 1, there is shown an exemplary raster input scanner, designated generally by the numeral 102, of the type adapted to use a scanning array, or sensor bar, 10. Sensor bar 10 comprises a linear full width array having a scan width in the fast scan direction substantially equal to or slightly greater than the width of the largest document or other object to be scanned. Documents to be scanned are supported on a generally rectangular transparent platen 104. A document to be scanned is located either manually or by a suitable automatic document handler or feeder (not shown) on platen 104 for scanning. Array 10 is supported for reciprocating scanning movement in the scan direction depicted by arrows 105 below platen 104 by a movable scanning carriage (not shown). A lens 106 focuses array 10 on a line like area extending across the width of platen 104. One or more lamp and reflector assemblies 107 are provided for illuminating the line-like area on which array 10 is focused.

Referring to FIG. 2, there is shown a long or full width, array or sensor bar 10 composed of a plurality of smaller sensor chips 12 assembled together end-to-end (specific chips are identified by numerals 12a, 12b, . . . 12n) on an elongated generally rectangular rigid substrate 13.

Chips 12, which may, for example, be charge coupled devices (CCDS) or MOS sensor arrays, are relatively thin silicon dies having a generally rectangular shape. A row of photosite areas 14 parallel the longitudinal axis of the chips. Other active elements such as shift registers, gates, pixel clock, etc., are preferably formed integrally with chips 12. Suitable external connectors (not shown) are provided for electrically coupling the chips 12 to related external circuitry.

Sensor bar 10 may for example be used to raster scan a document original, and in that application, the document original and the sensor array 10 are moved or stepped relative to one another in the slow scan direction perpendicular to the linear axis of array 10. At the same time, the array scans the document original line by line in the fast scan direction parallel to the linear axis of the array. The image line being scanned is illuminated and light from the document is focused onto the photosensors in photosite area 14. During an integration period, a charge is developed on each photosensor proportional to the reflectance of the image area viewed by each photosensor. The image signal charges are thereafter transferred to an output bus in a timed sequence, as described in detail in the patent incorporated by reference above.

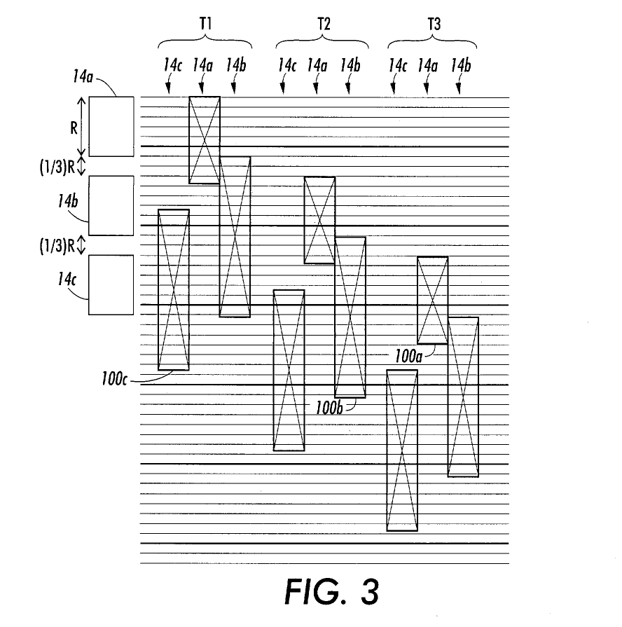

Referring to FIG. 3, each photosite area (such as 14 in FIG. 2) on a sensor bar 10 includes photosensors 14a, 14b, 14c, arranged along a process direction along which an image to be recorded moves relative to the linear array of photosites. Among a linear array of a large number of photosite areas 14 on a chip or bar, the individual photosensors 14a, 14b, 14c thus each form a separate linear array of photosensors. Generally speaking, each photosensor within a photosite area will “see” and thus record approximately the same small area of an image within a short time-span, as successive small areas of the image move over the sensor bar 10 as shown in FIG. 1. As illustrated on the left of the Figure, the three photosensors 14a-c are represented by rectangles which correspond to the relative size and spacing of the photosensitive areas associated with a photosensor found in a typical design of a sensor bar. As can be seen in the Figure, each photosensor 14a-c encompasses a length R in the process (vertical) direction as shown, and a border thereof is spaced from the border of another photosensor by one-third of a photosensor length, or 1/3 R. This particular spacing is typical of that required by the creation of photosensors on an integrated circuit.

As noted in the '411 patent mentioned above, by operating one photosensor with a relatively short integration (i.e., exposure) time, and a second photosensor with a relatively long integration time, the dynamic range of the overall apparatus can be significantly increased. With a particular embodiment of such an apparatus, such as the CMOS-based system generally described in the '514 patent described above, close manipulation of the timing and duration of the integration time of each photosensor within a photosite area can be readily carried out. Thus, by controlling the precise integration times, relative to roughly the same small area of an image being recorded by multiple photosensors per photosite, the effective dynamic range of a scanning apparatus can be greatly increased.

Further illustrated in FIG. 3 are three sets of columns, also indicated as 14a-c, corresponding to areas along the scan direction of an original image being scanned by each photosensor 14a-c with the passage of time. Although the areas associated with different photosensors are shown as separate columns, it will be apparent that in a real situation, the three columns are superimposed and follow the same path relative to an image or object being scanned. In the Figures, however, the behavior of the three photosensors is illustrated in separate columns for clarity. FIG. 3 shows the behavior of the photosensors 14a-c in three consecutive cycles of operation of the photosensors over time, the cycles being indicated as T1, T2, and T3: in reality, these sets of columns are themselves superimposed into a single column, so that all of FIG. 3 shows the exposure of one single column of an image to be recorded.

With the three photosensors moving continuously downward in the Figure to scan the original image, each rectangle with an “X” indicates the exposure duration of that particular photosensor, and the horizontal lines correspond to positions on the image being recorded. The center of each X in the Figure represents the center point, or “center of gravity,” of the particular small area of the image being scanned with each exposure duration. The fact that the area encompassed by each rectangle is larger than the area of an individual photosensor is caused by each of the photosensors 14a-c being “on” (exposing an area of the original image being scanned) for a particular exposure duration while the photosensors are continuously moving relative to the image being scanned.

In the embodiment of FIG. 3, with each cycle of operation, the rectangle showing the exposure behavior of photosensor 14a is smaller than the rectangles for photosensors 14b and 14c: this means that the exposure or “integration” time for photosensor 14a is shorter than those for photosensors 14b and 14c. In effect, for a given small area of an image being scanned, photosensor 14a takes a “short-exposure-time” recording of light from the image, while each photosensor 14b and 14c takes a “long-exposure-time” recording of light from the image. Each type of image recording is of value in a scanning process, and data from both types of image recording can be used or combined for various specific purposes, such as generally taught in the '411 patent referenced above.

In FIG. 3, the exposure areas indicated as 100a, 110b, and 100c are representative exposure areas “centering” largely around the same small area of the image to be recorded (bearing in mind that all of the columns in the Figure are superimposed on an image to be to be recorded). Through the three operational cycles T1, T2, and T3, one of each photosensor 14c, then 14b, and finally 14a, expose an area generally centering around the same small area of the image being scanned. It will further be noted that the centers of gravity of the two long exposures, 100b and 100c, are equidistant, in opposite directions, from the center of gravity of the short exposure 100a: thus, when signals from the two long exposures are combined, the combined signal represents a total exposure duration which is longer than either single long exposure time 100b or 100c individually, yet will itself have a combined center of gravity which is superimposed on the center of gravity of the short exposure time 100a. With regard to the small area on the original image around the center of gravity of short exposure 100a, it can be seen that the small area will be exposed by the photosensor 14a for the short period 100a, and by both photosensors 14b and 14c for an effectively long period: in this way, signals relating to both the short exposure and the long exposure result, for use in downstream image processing. In this embodiment, for any given small area in the image to be recorded, such as the small area around the centers of a gravity of exposure areas 100a, 110b, and 100c, three operational cycles T1, T2, T3 must be completed, and their outputs temporarily buffered.

To briefly summarize the operation of a photosensor array according to one embodiment, the order of scanning a particular small area of an image being recorded as three successive photosensors (or, photosensor arrays) pass over the small area (or, row of small areas on the image), is: long (exposure), long, and short; at the same time, the readout order of image-based signals, once the exposures have been made, is long, short, long. Put another way, with each small area, the first photosensor to expose is read out first, followed by the third photosensor to expose being read out, and finally with the second photosensor to expose being read out last. This difference in the readout order in time of the photosensor arrays, versus the integration time on each one of those arrays, facilitates a readout of information onto video lines with a relatively small amount of necessary signal buffering, as generally explained in the '139 patent referenced above.

The above-described embodiment provides a hard-copy scanner, such as shown in FIG. 1, with many practical advantages. First, the basic hardware of the embodiment, a sensor with three linear arrays, is generally familiar in the art, albeit in the form of a full-color scanning array wherein each linear array is associated with a primary-color filter, such as RGB. In the embodiment, the three linear arrays are generally not filtered with regard to any color (although in some applications, such filtering, all of the same color, or different colors for different linear arrays, may be desirable). Second, the fact that the two (or more in other embodiments) long-exposure-time photosensors' signals are combined facilitates an effective combined long exposure time which is twice (or more) the maximum possible exposure time of either single photosensor. In this way, the effective long exposure time can be made longer than would otherwise be possible given the basic hardware architecture of the sensor array. The significantly longer effective exposure time per small area can substantially increase the effective dynamic range of the whole apparatus. Third, the readout order of all three photosensors and the method of combining “long integration time” photosensors 14b and 14c allows row alignment with “short integration time” photosensor 14a, and also the maximum long integration time and minimum data output burst rate. The results are the best overall dynamic range at the minimum burst rate.

1. A method of operating a photosensitive apparatus, the apparatus having at least a first, second, and third photosensor, the method comprising:
moving a recordable image relative to the apparatus along a process direction, thereby exposing each photosensor to a series of small areas in the image;
operating the first photosensor with a first integration time relative to each small area in the image;
operating the second photosensor with a second integration time relative to each small area in the image; and
operating the third photosensor with a third integration time relative to each small area in the image;
wherein the first integration time and the second integration time are approximately equal, and are longer than the third integration time.

2. The method of claim 1, wherein the first photosensor and the second photosensor each define a length R along the process direction, and wherein the first photosensor is spaced by 1/3 R from the second photosensor.

3. The method of claim 1, wherein the first photosensor and the second photosensor are not filtered with regard to different colors.

4. The method of claim 1, wherein the first photosensor and the third photosensor are not filtered with regard to different colors.

5. The method of claim 1, wherein the second photosensor and the third photosensor are not filtered with regard to different colors.

6. The method of claim 1, wherein a center of gravity associated with operating the first photosensor, and a center of gravity associated with operating the second photosensor are spaced from each other on the image along the process direction.

7. The method of claim 1, wherein a center of gravity associated with operating the first photosensor and a center of gravity associated with operating the second photosensor are substantially equidistant along a process direction from a center of gravity associated with operating the third photosensor on the image.

8. The method of claim 1, wherein, for a small area in the image, the first integration time and the second integration time precede the third integration time.

9. The method of claim 1, further comprising
reading out image signals from the first photosensor, second photosensor, and third photosensor.

10. The method of claim 9, wherein, for a small area in the image, reading out an image signal from the third photosensor precedes reading out an image signal from one of the first photosensor and second photosensor.
